(19) United States
(12) Patent Application Publication
(10) Pub. No.: US 2014/0313105 A1
(43) Pub. Date: Oct. 23, 2014

(54) MEANS AND METHODS FOR SUPERIMPOSING AT LEAST ONE FIRST PROJECTED IMAGE OVER AT LEAST ONE SECOND REAL IMAGE

(71) Applicant: GAUZY LTD., Ra'anana (IL)

(72) Inventors: Eyal PESO, Tel Aviv (IL); Adrian LOFER, Kfar Saba (IL); Dimitri DOBRENKO, Raanana (IL)

(73) Assignee: GAUZY LTD., Ra'anana (IL)

(21) Appl. No.: 14/255,260

(22) Filed: Apr. 17, 2014

Related U.S. Application Data
(60) Provisional application No. 61/813,691, filed on Apr. 19, 2013.

(51) Int. Cl. G09G 3/00

(52) U.S. Cl. CPC G09G 3/003
USPC 345/4

(57) ABSTRACT

A system for reducing energy usage in a heat controlled device comprises a transparency adjustment device (TAD) including a transparent physical element whose electrical behavior is that of a capacitive load and a power dimmer apparatus operative to provide AC current to the transparent physical element to generate a set of transparency states between opaque and full transparent. The system also comprises a heat control device including a closed walled cavity and a thermometer adapted to control temperature in the cavity. The TAD is embedded in at least a portion of the cavity wall. The TAD reduces the thermometer energy consumption by enabling view of the cavity content without opening the cavity.

### FIELD OF THE INVENTION

The present invention generally pertains to means and methods for superimposing at least one first projected image over at least one second real image. The invention further relates to articles of manufacture (AOMs) comprising those superimposing means and to AOMs operatable by those superimposing methods.

### BACKGROUND OF THE INVENTION

Means and method of generating a high-resolution image by superimposing multiple low-resolution images projected by different projectors are known in the art, see e.g., Okatani, T.; Wada, M.; Deguchi, K., “Study of Image Quality of Superimposed Projection Using Multiple Projectors,” Image Processing, IEEE Transactions on, 18(2), pp. 424-29, Feb. 2009. In these technologies, two or more unreal-images, e.g., one or more video, one or more photos etc are superimposed for the prepuce of improving image quality.

It is still a long felt need to superimpose a patterned, times resolved projected unreal image over a real image or a real at least partially transparent screen.

### SUMMARY OF THE INVENTION

It is thus an object of the invention to disclose a system for reducing energy usage and loss thereof in a heat controlled device (HCD) comprising: a transparency adjustment device (TAD) comprising: a transparent physical element whose electrical behavior is that of a capacitive load; and a power dimmer apparatus operative to provide AC current to said transparent physical element to generate a set of transparency states between opaque and full transparent; and a heat control device comprising: (i) a closed walled cavity; and (ii) a thermometer adapted to control temperature in said cavity; wherein said TAD is embedded in at least a portion of said cavity wall; further wherein said TAD reduces said thermometer energy consumption by enabling view of said cavity content without opening said cavity.

It is another object of the invention to disclose the system as defined in any of the above, wherein said transparent physical element comprises a liquid crystal (LC) film.

It is another object of the invention to disclose the system as defined in any of the above, wherein said set of transparency states also includes a state of full transparency.

It is another object of the invention to disclose the system as defined in any of the above, wherein said load comprises a complex capacitor/resistor load.

It is another object of the invention to disclose the system as defined in any of the above, wherein said power dimmer apparatus comprises: a power switch powering said load; and control circuit controlling the power switch to turn on and off at selectable portion of said LC film.

It is another object of the invention to disclose the system as defined in any of the above, wherein, in order to drive the load, an output voltage which is applied to the load, comprises AC voltage, such that DC voltage, if any, is at most 0.5% of the amount of AC voltage.

It is another object of the invention to disclose the system as defined in any of the above, wherein the power switch is connected in series with said load.

It is another object of the invention to disclose the system as defined in any of the above, wherein the power switch comprises a pair of anti-serial MOSFET switches connected in series with the LC film.

It is another object of the invention to disclose the system as defined in any of the above, wherein the power switch comprises: a diode bridge; and a MOSFET switch connected serially with the load via the diode bridge.

It is another object of the invention to disclose the system as defined in any of the above, wherein AC voltage applied to the load is of a quasi trapezoidal form.

It is another object of the invention to disclose the system as defined in any of the above, wherein AC voltage applied to the load has a truncated sinusoidal form.

It is another object of the invention to disclose the system as defined in any of the above, wherein said liquid crystal film is laminated into a glass object thereby to control transparency of the glass object.

It is another object of the invention to disclose the system as defined in any of the above, wherein said glass object forms one of: window pane, a window, a glass door pane, and a glass door.

It is another object of the invention to disclose the system as defined in any of the above, wherein AC voltage applied to the load has a truncated sinusoidal form which is truncated at a voltage level determined by the control circuit and applied via the power switch.

It is another object of the invention to disclose the system as defined in any of the above, wherein a maximum voltage level rating is defined for the liquid crystal film and wherein the power dimmer apparatus has a predetermined maximum voltage level which does not exceed the liquid crystal film's maximum voltage level rating.

It is another object of the invention to disclose the system as defined in any of the above, wherein the power switch has an input point comprising a gate and wherein the control circuit is connected to the power switch via a driver circuit controlling the power switch's input point.

It is another object of the invention to disclose the system as defined in any of the above, wherein the control circuit includes a comparator operative to receive and to compare: an incoming level of AC voltage; and a user-selected reference voltage; and operative, when the incoming level of AC voltage reaches the user-selected reference voltage, to generate an output triggering truncation of sinusoidal AC voltage applied to the load.

It is another object of the invention to disclose the system as defined in any of the above, wherein the control circuit is connected to the driver circuit via an isolation circuit.

It is another object of the invention to disclose the system as defined in any of the above, wherein it comprising a capacitor disposed in parallel to the complex load and operative to increase AC voltage applied to the complex load.

It is another object of the invention to disclose the system as defined in any of the above, wherein it comprising ZVC (zero-voltage-crossing) prediction circuitry, and wherein the power switch is not turned on unless zero or at most presence of less than a predeterminedly small level of voltage is predicted by the ZVC (zero-voltage-crossing) prediction circuitry to be present across the power switch.

It is another object of the invention to disclose the system as defined in any of the above, wherein the ZVC (zero-voltage-crossing) prediction circuitry assumes that LC voltage during a “floating” time interval will not change.

It is another object of the invention to disclose the system as defined in any of the above, wherein it comprising ZVC (zero-voltage-crossing) detection circuitry connected across the power switch, and wherein the power switch is not turned on unless very little voltage, if any, is detected by the ZVC detection circuitry across the power switch.

It is another object of the invention to disclose the system as defined in any of the above, wherein the ZVC detection circuitry is operative to measure positive and negative half cycles of a sine input voltages across terminals P-VDD1 and LC-VDD1 of the power switch, respectively.

It is another object of the invention to disclose the system as defined in any of the above, wherein said capacitive load comprises a complex capacitor/resistor load, the system also comprising a capacitor in parallel to the complex capacitive/resistive load.

It is another object of the invention to disclose the system as defined in any of the above, wherein the power dimmer apparatus is manually controllable by a user.

It is another object of the invention to disclose the system as defined in any of the above, wherein the power dimmer apparatus is controllable by a computerized system such as a PC or smart home system.

It is another object of the invention to disclose the system as defined in any of the above, wherein said cavity is selected from a group consisting of: a refrigerator, an oven, a boiler, a micro-oven, an engine.

It is another object of the invention to disclose the system as defined in any of the above, wherein said cavity additionally comprising a door.

It is another object of the invention to disclose the system as defined in any of the above, wherein said door additionally comprising a sealing rubber.

It is another object of the invention to disclose the system as defined in any of the above, wherein said TAD is embedded in different places of said cavity wall.

It is another object of the invention to disclose the system as defined in any of the above, wherein said TAD is movable along said cavity wall.

It is another object of the invention to disclose a method for reducing energy usage and loss thereof in a heat controlled device (HCD) comprising steps of providing (a) transparency adjustment device (TAD) comprising: a transparent physical element whose electrical behavior is that of a capacitive load; and power dimmer apparatus operative to provide AC current to said transparent physical element to generate a set of transparency states between opaque and full transparent; and a heat control device comprising: (i) a closed walled cavity; and (ii) a thermometer adapted to control temperature in said cavity; wherein said method additionally comprising steps of: embedding said TAD in at least one portion of said cavity wall; and reducing said thermometer energy consumption by enabling view of said cavity content without opening said cavity.

It is another object of the invention to disclose the system as defined in any of the above for reducing energy usage and loss thereof in a heat controlled device (HCD) comprising: transparency adjustment device (TAD) comprising: a transparent physical element whose electrical behavior is that of a capacitive load; and power dimmer apparatus operative to provide AC current to said transparent physical element to generate a set of transparency states between opaque and full transparent; a heat control device comprising: (i) a walled cavity comprising a seal with sealing means; and (ii) a thermometer adapted to control temperature in said cavity; wherein said TAD is embedded in at least a portion of said cavity wall; further wherein said TAD reduces erosion of said sealing means by enabling view of said cavity content without opening said cavity.

It is another object of the invention to disclose a method for reducing energy usage and loss thereof in a heat controlled device (HCD) comprising steps of: providing (a) transparency adjustment device (TAD) comprising: a transparent physical element whose electrical behavior is that of a capacitive load; and power dimmer apparatus operative to provide AC current to said transparent physical element to generate a set of transparency states between opaque and full transparent; and a heat control device comprising: (i) a walled cavity comprising a seal with sealing means; and (ii) a thermometer adapted to control temperature in said cavity; wherein said method additionally comprising steps of: embedding said TAD in at least one portion of said cavity wall; and reducing erosion of said sealing means by enabling view of said cavity content without opening said cavity.

It is another object of the invention to disclose a system for shading a closed cavity comprising: at least one surface at least partially comprising a transparency adjustment device (TAD) comprising: a transparent physical element whose electrical behavior is that of a capacitive load; and power dimmer apparatus operative to provide AC current to said transparent physical element to generate a set of transparency states between opaque and full transparent; and a cavity comprising said at least one surface buffering between (i) inside of said cavity; and (ii) outside of said cavity wherein said power dimmer controls shading of said cavity by change of transparency state of said transparent physical element.

It is another object of the invention to disclose the system as defined in any of the above, wherein said cavity is selected from a group consisting of: car, truck, airplane, elevator, train, bus and watercraft.

It is another object of the invention to disclose the system as defined in any of the above, wherein said TAD is embedded in a surface selected from a group consisting of: said car window, sunroof and a combination thereof.

It is another object of the invention to disclose a method for shading a closed cavity comprising steps of: providing at least one surface at least partially comprising a transparency adjustment device (TAD) comprising: a transparent physical element whose electrical behavior is that of a capacitive load; and power dimmer apparatus operative to provide AC current to said transparent physical element to generate a set of transparency states between opaque and full transparent; buffering between (i) inside of said cavity; and (ii) outside of said cavity, using said at least one surface; wherein shading said cavity is by changing of transparency state of said transparent physical element using said power dimmer.

It is another object of the invention to disclose a system for providing privacy in shared rooms comprising: a plurality of N spaces; N is an integer larger than 1; a plurality of N−1 transparency adjustment device (TAD) comprising: a transparent physical element whose electrical behavior is that of a capacitive load; and power dimmer apparatus operative to provide AC current to said transparent physical element to generate a set of transparency states between opaque and full transparent; wherein each of said N−1 TAD is separating between a couple of said personal spaces.

It is another object of the invention to disclose a method for providing privacy in shared rooms comprising providing a plurality of N−1 transparency adjustment device (TAD) comprising: a transparent physical element whose electrical behavior is that of a capacitive load; and power dimmer apparatus operative to provide AC current to said transparent physical element to generate a set of transparency states between opaque and full transparent; placing each of said TAD between a couple of spaces selected from a plurality of N spaces; N is an integer larger than 1 wherein each of said N−1 TAD is separating between a couple of said personal spaces.

It is another object of the invention to disclose acsystem for concealment of lightning system comprising: at least one surface; said surface is characterized by N parameters; at least one of said N parameters is a transparency parameter; a lightning system recessed inset into said at least one first surface; at least one transparency adjustment device (TAD) comprising: a transparent physical element whose electrical behavior is that of a capacitive load; and power dimmer apparatus operative to provide AC current to said transparent physical element to generate a set of transparency states between opaque and full transparent; said TAD is configured to cover said lightning system; wherein said TAD is configured to be in a transparent state synchronically with operation of said lighting system.

It is another object of the invention to disclose the system as defined in any of the above, wherein said TAD is additionally configured

It is another object of the invention to disclose a screen dynamically interacting with images comprising: a plurality of N transparency adjustment devices (TAD) constructed in structured layers; said TAD comprising: a transparent physical element whose electrical behavior is that of a capacitive load; and power dimmer apparatus operative to provide AC current to said transparent physical element to generate a set of transparency states between opaque and full transparent; each of said TAD is characterized by a color; wherein each of said layers is adapted to be independently configured to a different transparency state; thereby screen is adapted to transfer a predetermined portion of an image projected on said screen.

It is another object of the invention to disclose a screen for superimposing projected image and real objects comprising: a transparency adjustment devices (TAD) constructed in structured layers; said TAD comprising: a transparent physical element whose electrical behavior is that of a capacitive load; and power dimmer apparatus operative to provide AC current to said transparent physical element to generate a set of transparency states between opaque and full transparent; said TAD is posted between a projector and an object; wherein said TAD is adapted to partially transfer an image projected on said TAD by said projector; thereby superimposing said image and said object.

It is another object of the invention to disclose a transparent physical element as defined in any of the above, whose electrical behavior is that of a capacitive load for superimposing at least one first projected image over at least one second real image.

It is another object of the invention to disclose a power dimmer apparatus as defined in any of the above, operative to provide AC current to a transparent physical element to generate a set of transparency states between opaque and full transparent for superimposing at least one first projected image over at least one second real image.

It is another object of the invention to disclose a transparency adjustment device (TAD) constructed in structured layers for superimposing at least one first projected image over at least one second real image; said TAD comprising: a transparent physical element whose electrical behavior is that of a capacitive load; and power dimmer apparatus operative to provide AC current to said transparent physical element to generate a set of transparency states between opaque and full transparent; said TAD is posted between a projector and an object.

The present invention discloses various applications, AOMs and methods for superimposing a patterned, times resolved projected unreal image over a real image or a real at least partially transparent screen.

### BRIEF DESCRIPTION OF THE DRAWINGS

In order to understand the invention and to see how it may be implemented in practice, a plurality of embodiments is adapted to now be described, by way of non-limiting example only, with reference to the accompanying drawings, in which:

FIG. 1 is a graph of heat losses;

FIGS. 2a-2d are schematic views of a transparent physical element;

FIGS. 3a and 3b are schematic views of a showcase; and

FIG. 4 is a schematic view of a compartment premises formed by transparent physical elements.

### DETAILED DESCRIPTION OF THE INVENTION

The term “liquid crystal” hereinafter refers to a polymer dispersed liquid crystal film or glass including a polymer dispersed (among them low-molar-mass) liquid crystal film or glass abbreviated as PDLC, PDSLC, PDCLC and PDNLC, respectively. Suspended particle and electrochromic devices are in the scope of the abovementioned definition.

### Example 1

Energy saving by superimposing at least one first projected image over at least one second real image.

Cool temperature loss According to Home Energy Magazine, door openings account for 7% of home fridge energy use while the Institute of Food and Agricultural Sciences at the University of Florida indicates that poor open/close habits waste 50 to 120 kWh a year, see http://www.thedailygreen.com/going-green/tips/refrigerator-door-wastes-energy#ixzz2QplI8fyz.

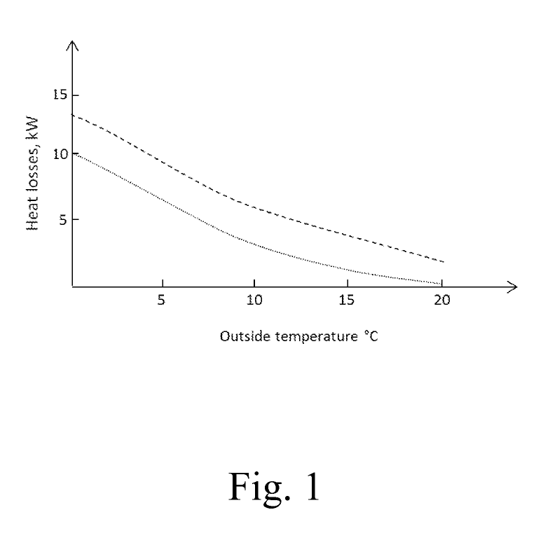

The graph in FIG. 1 illustrates that heat loss which depends on the size of door and inside and outside temperature. The graph shows the calculated heat loss based on stack effect alone (thermal buoyancy) for a range of outside temperatures, at two inside temperatures, for a regular sized door (1.98 m high by 0.79 m wide aperture).

The 6 kW of heat lost through the door at a relatively mild 10° C. outside. At 0° C. outside, it's a massive 13 kW. This huge heat loss is useful when power fails and the only ventilation is by leaving the door open.

Utilizing the technology described hereinafter, thereby providing a predefined screen or a screen-like object, such as a door, cap or a wall, with either a scaled transparency (transparency between 0% to 100%), namely partial (patterned or not) or complete transparency, superimposed image is provided. The superimposed image hybrids a real image (e.g., the image of the door, cap or wall image and pattern thereof) and a projected image (e.g., a view if the other side of the door, cap or wall). The screen or the screen-like object can be thus set to be partially transparent, thereby both screen's pattern, color, texture etc is seen, whilst its partial transparency enable the viewer to see projected view of the other side of the screen. This projected image can be ‘passive’, namely an image AS IS; ‘active’, namely optically manipulated image (by adding or changing light parameters, projecting one or more video contents etc; or both: partially passive image and partially active image. Moreover, the superimposed image can be projected all over the screen, in at least one or two or more portions of the screen, in a puzzle-like manner, in a patterned or textured manner, in a 2D manner or a 3D manner, in continuous—a non-interrupted manner or in a set of one by one, or along a train of several pulses, in a time-resolved manner or parameter-resolved manner, wherein parameter can be selected from temperature, relative humidity, location, user location and movement, etc. The superimposing of the images can be a result of a feedback or reaction, such as user gestures, sound or music patterns, computer programmed commands etc.

The present invention thus enables for example, coolers and heaters, such as home-used Fridge door or a food dispensing machine located in a point-of-care or any other commercial area, that is embedded with the herein defined technology to enable the user to look inside the Fridge without opening the door (in either complete or partial manner) which will thus save energy on the re cooling of the engine but also reduce wear out on the rubber (known to be the weakest link) which seals the door (hence avoiding more cooling as it wears out).

### Example 2

Increasing safety and comfort by superimposing at least one first projected image over at least one second real image.

Some of the car accidents are caused by dazzle, sun reflections and strong light's emission. Moreover, a few of those dazzle-type car accidents is caused not because the driver was dazzled directly, yet in an indirect manner when one of the passengers, such as toddlers sitting in the rear sit are dazzled, and the driver is asked to operate the car to cure the dazzle.

It is further noted that EPO498143 discloses that dazzle caused by the sun and headlights, is very annoying for a driver (especially when meeting a column of cars coming in the opposite direction or during rain when visibility is reduced and reflections from the road surface are increased) and is also a very serious road traffic hazard which can lead to accidents; dazzle is particularly common on badly lit roads requiring the use of headlights on main beam which are not always dipped by drivers when meeting oncoming traffic. Thus, dazzle deteriorate the comfort in driving, and cause less-experienced driver faster, and in a less safe manner. Avoidance of both direct- or indirect- driver's dazzle increases thus both safety and comfort.

Much more than that! The present invention discloses new means and inventive methods whereupon superimposing at least one first projected image over at least one second real image enables or even increases zone of comfort.

The comfort zone is a behavioral state within which a person operates in an anxiety-neutral condition, using a limited set of behaviors to deliver a steady level of performance, usually without a sense of risk (White 2009, as indicated below. For all text, incorporated herein as a reference, see Wikipedia). A person's personality can be described by his or her comfort zones. Highly successful persons may routinely step outside their comfort zones, to accomplish what they wish. A comfort zone is a type of mental conditioning that causes a person to create and operate mental boundaries. Such boundaries create an unfounded sense of security. Like inertia, a person who has established a comfort zone in a particular axis of his or her life, will tend to stay within that zone without stepping outside of it. To step outside their comfort zone, a person must experiment with new and different behaviours, and then experience the new and different responses that occur within their environment. To step out of the comfort zone raises the anxiety level engendering a stress response, the result of which is an enhanced level of concentration and focus. White (2009) refers to this as the Optimal Performance Zone—a zone in which the performance of a person can be enhanced and in which their skills can be optimized. However, White (2009) also observes that if the work of Robert Yerkes (1907) is considered in which he reported ‘Anxiety improves performance until a certain optimum level of arousal has been reached. Beyond that point, performance deteriorates as higher levels of anxiety are attained’, if a person steps beyond the optimum performance zone they enter a “danger zone” in which performance will decline rapidly as higher levels of anxiety or discomfort occur; See Bardwick, Judith. Danger in the Comfort Zone: How to Break the Entitlement Habit that's Killing American Business. New York: American Management Association, 1995; White, Alasdair A. K. “From Comfort Zone to Performance Management” White & MacLean Publishing 2009; and Yerkes, R & Dodson, J. “The Dancing Mouse, A Study in Animal Behavior” 1907 “Journal of Comparative Neurology & Psychology”, Number 18, pp 459-482, that are incorporated herein as a reference.

### Thermal Comfort

Thermal comfort is the condition of mind that expresses satisfaction with the thermal environment and is assessed by subjective evaluation (ANSI/ASHRAE Standard 55[1] which is incorporated herein as a reference). Maintaining this standard of thermal comfort for occupants of buildings or other enclosures is one of the important goals of HVAC (heating, ventilation, and air conditioning) design engineers. Predicted Mean Votes (PMV) model stand among the most recognized model developed in controlled climate chamber from the heat balance approach under steady state condition. In the era of increasingly expensive fuel and with the theoretical complication and the limitation of comfort prediction in naturally ventilate d buildings based on thermal balance approach; researchers were motivated to go beyond heat balance approach to predict occupants' thermal comfort using statistical approach known by adaptive models. From the adaptive approach perspective, the occupant in a naturally ventilated building is considered a dynamic subject who interacts with the surrounding environment and adjusts to the indoor temperature accordingly; and not a static passive occupant subjected only to external and internal factors.

Thermal comfort is affected by heat conduction, convection, radiation, and evaporative heat loss. Thermal comfort is maintained when the heat generated by human metabolism is allowed to dissipate, thus maintaining thermal equilibrium with the surroundings. It has been long recognized that the sensation of feeling hot or cold is not just dependent on air temperature alone. Thermal comfort calculations according to ANSI/ASHRAE Standard 55 can be freely performed with the CBE Thermal Comfort Tool for ASHRAE-55.

The radiant temperature is related to the amount of radiant heat transferred from a surface, and it depends on the emissivity of the material—i.e. the ability to absorb or emit heat. The mean radiant temperature, defined as the uniform temperature of an imaginary enclosure in which the radiant heat transfer from the human body is equal to the radiant heat transfer in the actual non-uniform enclosure, is a key variable for thermal comfort calculations for the human body.

### Local Thermal Discomfort

Even though the comfort models based on the predicted mean vote (PMV) and predicted percentage of dissatisfied (PPD) usually describe compliance to thermal comfort for the body as a whole, thermal dissatisfaction may also occur just for a particular part of the body, due to local sources of unwanted heating, cooling or air movement. According to the ASHRAE 55-2010 standard, there are four main causes of thermal discomfort to be considered. A section of the standard specifies the requirements for these factors, that apply to a lightly clothed person engaged in near sedentary physical activity. This is because people with higher metabolic rates and/or more clothing insulation are less thermally sensitive, and consequently have less risk of thermal discomfort.

### Radiant Temperature Asymmetry

The thermal radiation field about the body may be nonuniform due to hot and cold surfaces and direct sunlight. This asymmetry may cause local discomfort and reduce the thermal acceptability of the space. In general, people are more sensitive to asymmetric radiation caused by a warm ceiling than that caused by hot and cold vertical surfaces. ASHRAE standard gives the predicted percentage of dissatisfied occupants (PPD) as a function of the radiant temperature asymmetry and specifies the acceptable limits.

### Draft

Draft is unwanted local cooling of the body caused by air movement, most prevalent when the thermal sensation of the whole body is cool (below neutral). Draft sensation depends on the air speed, air temperature, activity, and clothing. Sensitivity to draft is greatest where the skin is not covered by clothing, especially the head, neck, shoulders, ankles, feet, and legs.

### Vertical Air Temperature Difference

Thermal stratification that results in the air temperature at the head level being higher than at the ankle level may cause thermal discomfort. ASHRAE standard 55 gives the predicted percentage of dissatisfied occupants as a function of the air temperature difference between the head level and ankle level. Thermal stratification in the opposite direction is rare and perceived more favorably by occupants.

### Floor Surface Temperature

Occupants may feel uncomfortable due to contact with floor surfaces that are too warm or too cool. The temperature of the floor, rather than the material of the floor covering, is the most important factor for foot thermal comfort for people wearing shoes. ASHRAE standard 55 specifies the allowable range of surface temperatures of the floor for people wearing lightweight shoes.

### Thermal Stress

The concept of thermal comfort is closely related to thermal stress. This attempts to predict the impact of solar radiation, air movement, and humidity for military personnel undergoing training exercises or athletes during competitive events. Values are expressed as the Wet Bulb Globe Temperature or Discomfort Index. Generally, humans do not perform well under thermal stress. People's performances under thermal stress are about 11% lower than their performance at normal thermal conditions. Also, human performance in relation to thermal stress varies greatly by the type of task you are completing. Some of the physiological effects of thermal heat stress include increased blood flow to the skin, sweating, and increased ventilation.

### Thermal Comfort Models

When discussing thermal comfort, there are two main different models that can be used: the static model (PMV/PPD) and the adaptive model.

### Static Comfort Model

The static model is based on the physiological approach, according to which the comfort zone can be the same for all occupants, disregarding location and adaptation to the thermal environment. It basically states that the indoor temperature should not change as the seasons do. Rather, there should be one set temperature year-round. This is taking a more passive stand that humans do not have to adapt to different temperatures since it will always be constant.

This model is based on the PMV/PPD model that uses the Predicted Mean Vote formula by P. O. Fanger. The PMV is the average comfort vote, using a seven-point thermal sensation scale from cold (−3) to hot (+3), predicted by a theoretical index for a large group of subjects when exposed to particular environmental conditions. Zero is the ideal value, representing thermal neutrality. This model was originally developed by collecting data from a large number of surveys on people subjected to different conditions within a climate chamber. These data were then used to derive a mathematical model of the relationship between all the environmental and physiological factors involved. The comfort zone is defined by the combinations of the six key factors for thermal comfort for which the PMV is within the recommended limits (−0.5<PMV<+0.5). The PMV model is calculated with the air temperature and mean radiant temperature in question along with the applicable metabolic rate, clothing insulation, air speed, and humidity. If the resulting PMV value generated by the model is within the recommended range, the conditions are within the comfort zone.

The Predicted Percentage of Dissatisfied (PPD) is related to the PMV as is defined as an index that establishes a quantitative prediction of the thermally dissatisfied people assuming that who votes −2, −3, +2 or +3 on the thermal sensation scale is dissatisfied. The model is also based on the simplification that PPD is symmetric around a neutral PMV.

ASHRAE Standard 55-2010 sets an acceptable range of conditions that must be complied in order to apply this method and draw the comfort zone: occupants' metabolic rates between 1.0 and 1.3 met, clothing between 0.5 and 1.0 do, air speeds under 0.2 m/s.

### Elevated Air Speed Method

According to the standard, a different model is to be used to allow a higher air speed, in order to increase the maximum operative temperature for acceptability under certain conditions. The Elevated Air Speed Method is based on the fact that different combinations of air movement and temperatures may result in equal levels of heat loss from the skin. The model applies to a lightly clothed person who is engaged in near sedentary activity. As a matter of fact, any benefits gained by increasing air speed depend mainly on clothing and metabolic activity. Elevated air speed is more effective at increasing heat loss with lower levels of clothing and if the occupant is engaged in higher activities, so in this case the method would be conservative. Clothing insulation higher than 0.7 do would lead to a wrong estimation of the effects of increased air movement.

### Adaptive Comfort Model

The adaptive model is based on the concept that there is a strong relationship between indoor comfort and outdoor climate, taking into account that humans can adapt to and tolerate different temperatures during different times of the year. The adaptive hypothesis predicts that contextual factors and past thermal history modify building occupants' thermal expectations and preferences. Field studies are performed in these areas to see what the majority of people would prefer as their set-point temperature indoors at different times of the year.

The ASHRAE-55 2010 Standard has recently introduced the prevailing mean outdoor temperature as input variable for the adaptive model. It is based on the arithmetic average of the mean daily outdoor temperatures (DBT) over no fewer than 7 and no more than 30 sequential days prior to the day in question. It can also be calculated by weighting the temperatures with different coefficients, assigning increasing importance to the most recent temperatures. In case this weighting is used, there is no need to respect the upper limit for the subsequent days. In order to apply the adaptive model the prevailing mean temperature calculated must be greater than 10° C. (50° F.) and less than 33.5° C. (92.3° F.) and some other criteria must be met according to the standard.

This model applies especially to occupant-controlled, natural conditioned spaces, where the outdoor climate can actually affect the indoor conditions and so the comfort zone. In fact, studies by de Dear and Brager showed that occupants in naturally ventilated buildings were tolerant of a wider range of temperatures. This is due to both behavioral and physiological adjustments, since there are different types of adaptive processes. ASHRAE Standard 55-2010 states that differences in recent thermal experiences, changes in clothing, availability of control options and shifts in occupant expectations can change people thermal responses. There are basically three categories of thermal adaptation, namely Behavioral Adjustment, Physiological and Psychological. The latter, that refers to an altered thermal perception and reaction due to past experiences and expectations, is the key factor to explain the difference between field observations and PMV predictions (based on the static model) in naturally ventilated buildings. In these buildings the relationship with the outdoor temperatures is twice as strong as predicted.

More advanced research on thermal comfort considers the heat balance of the human body and calculates sensation and comfort for local body parts.

### Thermal Comfort in Different Regions

In different areas of the world, thermal comfort needs may vary based on climate. In China there are hot humid summers and cold winters causing a need for efficient thermal comfort. Energy conservation in relation to thermal comfort has become a large issue in China in the last several decades due to rapid economic and population growth. Researchers are now looking into ways to heat and cool buildings in China for lower costs and also with less harm to the environment.

In tropical areas of Brazil, urbanization is causing a phenomenon called urban heat islands (UHI). These are urban areas, which have risen over the thermal comfort limits due to a large influx of people and only drop within the comfortable range during the rainy season. Urban Heat Islands can occur over any urban city or built up area with the correct conditions. Urban Heat Islands are caused by urban areas with few trees and vegetation to block solar radiation or carry out evapotranspiration, many structures with a large proportion of roofs and sidewalks with low reflectivity that absorb heat, high amounts of ground-level carbon dioxide pollution that retains heat released by surfaces, great amounts of heat generated by air conditioning systems of densely packed buildings and large amount of automobile traffic generating heat from engines and exhaust.

In the hot humid region of Saudi Arabia, the issue of thermal comfort has been important in mosques where Muslims go to pray. They are very large open buildings which are used only intermittently (very busy for the noon prayer on Fridays) making it hard to ventilate them properly. The large size requires a large amount of ventilation but this requires a lot of energy since the buildings are used only for short periods of time. Some mosques have the issue of being too cold from their HVAC systems running for too long and others remain too hot. The stack effect also comes into play due to their large size and creates a large layer of hot air above the people in the mosque. New designs have placed the ventilation systems lower in the buildings to provide more temperature control at ground level. Also new monitoring steps are being taken to improve the efficiency.

### Thermal Comfort of Livestock

Although thermal comfort of humans is the main focus of thermal comfort studies, the needs of livestock must be met as well for better living and production. The Department of Animal Production in Italy produced a study on ewes, which tested rumen function and diet digestibility of ewes chronically exposed to a hot environment. These two bodily functions were reduced by the hot temperatures offering insight that thermal comfort levels are important to livestock productivity.

### Thermal Comfort for Patients and Hospital Staff

Whenever the studies referenced tried to discuss the thermal conditions for different groups of occupants in one room, the studies ended up simply presenting comparisons of thermal comfort satisfaction based on the subjective studies. No study tried to reconcile the different thermal comfort requirements of different types of occupants who compulsorily must stay in one room. Therefore, it looks to be necessary to investigate the different thermal conditions required by different groups of occupants in hospitals to reconcile their different requirements in this concept. To reconcile the differences in the required thermal comfort conditions it is recommended to test the possibility of using different ranges of local radiant temperature in one room via a suitable mechanical system.

Although different researches are undertaken on thermal comfort for patients in hospitals, it is also necessary to study the effects of thermal comfort conditions on the quality and the quantity of healing for patients in hospitals. There are also original researches that show the link between thermal comfort for staff and their levels of productivity, but no studies have been produced individually in hospitals in this field. Therefore, researches for coverage and methods individually for this subject are recommended. Also research in terms of cooling and heating delivery systems for patients with low levels of immune system protection such as HIV patients, burned patients, etc are recommended. However, there is research that shows the link between thermal comfort for staff and their levels of productivity, but no study have been produced in hospitals in this field. There are important areas, which still need to be focused on including thermal comfort for staff and its relation with their productivity, using different heating system to prevent hypothermia in the patient and to improve the thermal comfort for hospital staff simultaneously.

Finally, the interaction between people, systems and architectural design in hospitals is a field in which require further work needed to improve the knowledge of how to design buildings and systems to reconcile many conflicting factors for the people occupying these buildings.

The following citations, currently available in Wikpedia, are incorporated herein as a reference: ANSI/ASHRAE Standard 55-2010, Thermal Environmental Conditions for Human Occupancy; Djamila, Harimi; Sivakumar k, Chi-Ming Chu (2012). “A Conceptual Review on Residential Thermal Comfort in the Humid Tropics”. International Journal of Engineering Innovation & Research. ISSN: 2277-5668 1 (6): 539-544; Djamila, Harimi; Chi-Ming Chu, Sivakumar K. “Hot and humid climate: prospect for thermal comfort in residential building”. Building and Environment 62: 133-142; “Impact of indoor air temperature and humidity in an office on perceived air quality, SBS symptoms and performance”. Indoor Air. International Centre for Indoor Environment and Energy, Technical University of Denmark. 2004; Myhren, J. A.; Holmberg, S. (2008). “Flow patterns and thermal comfort in a room with panel, floor and wall heating” (PDF). Energy and Buildings, 40(4), 524-536; Toftum, J. (2005). Handbook of Human Factors and Ergonomics Methods. Boca Raton, Fla., USA: 63.CRC Press; Smolander, J. (2002). “Effect of cold exposure on older humans”. International Journal of Sports Medicine 23 (2): 86; Khodakarami, J. (2009). Achieving thermal comfort. VDM Verlag; Thermal Comfort chapter, Fundamentals volume of the ASHRAE Handbook, ASHRAE, Inc., Atlanta, Ga., 2005; Szokolay, Steven V. (2010). The Basis of Sustainable Design, Second Edition. pp. 16-22; Havenith, G. (1999). “Heat balance when wearing protective clothing”. The Annals of Occupational Hygiene 43 (5): 289; McCullough; Eckels; Harms (2009). “Determining temperature ratings for children's cold weather clothing”. Applied Ergonomics 40 (5): 870-7; La Roche, P. (2011). Carbon-neutral architectural design, CRC Press; Balaras; Balaras (2007). “HVAC and indoor thermal conditions in hospital operating rooms”. Energy and Buildings 39 (4): 454; Wolkoff, S. K.; Kjaergaard (2007). “The dichotomy of relative humidity on indoor air quality”. Environment International 33 (6): 850; Montanini, R (2007). “Wavelength-encoded optical psychrometer for relative humidity measurement”. Review of Scientific Instruments 78 (2); Toida; TOIDA (2006). “A method for measuring dry-bulb temperatures during the operation of a fog system for greenhouse cooling”. Biosystems Engineering 93 (3): 347; Fukazawa, T.; Havenith, G. (2009). “Differences in Comfort Perception in Relation to Local and Whole Body Skin Wettedness”. European Journal of Applied Physiology 106 (1): 15-24; Hashiguchi, N.; Tochihara, Y. (2009). “Effects of Low Humidity and High Air Velocity in a Heated Room on Physiological Responses and Thermal Comfort After Bathing: An Experimental Study”. International Journal of Nursing Studies 46 (2): 172-179; ISO/FDIS 7730:2005, International Standard, Ergonomics of the thermal environment—Analytical determination and interpretation of thermal comfort using calculation of the PMV and PPD indices and local thermal comfort criteria; “About the WBGT and Apparent Temperature Indices”; Hancock, P. A.; Ross, J. L.; Szalma, (2007). “A meta-analysis of performance response under thermal stressors”. Human Factors 49 (5): 851; Leon, L. R. (2008). “Thermoregulatory responses to environmental toxicants: The interaction of thermal stress and toxicant exposure”. Toxicology and Applied Pharmacology 233 (1): 146; Szokolay, Steven V. (2010). “Introduction to Architectural Science”. The Basis of Sustainable Design, Second Edition: 19; Fordham (2000). “Natural ventilation”. Renewable Energy 19 (1-2): 17; Omer; OMER (2008). “Renewable building energy systems and passive human comfort solutions”. Renewable Sustainable Energy Reviews 12 (6): 1562; de Dear, R. (2004). “Thermal comfort in practice”. Indoor Air 14 (Suppl 7): 32; Olesen, B. W. (2004). “International standards for the indoor environment”. Indoor Air 14 (Suppl 7): 18; Lenzuni, P.; Freda, D.; Del Guadio, M. (2008). “Classification of Thermal Environments for Comfort Assessment”. The Annals of Occupational Hygiene; D. P. Wyon, I. Andersen and G. R. Lundqvist, “Spontaneous Magnitude Estimation of Thermal Discomfort during Changes in the Ambient Temperature”, The Journal of Hygiene 1972, pp 203-221; Karjalalainen, S. (2007). Gender Differences in Thermal Comfort and use of thermostats in everyday thermal environments. Building and Environment, 42(1594-1603); Lan, L., Lian, Z., Liu, W., & Liu, Y. (2008). Investigation of gender difference in thermal comfort for Chinese people. European Journal of Applied Physiology, 102(4), 471; Ye, X. J., Zhou, Z. P., Lian, Z. W., Liu, H. M., Li, C. Z., & Liu, Y. M. (2006). Field study of a thermal environment and adaptive model in shanghai. Indoor Air, 16(4), 320-326; Khodakarami J, Knight I. Required and current thermal conditions for occupants in Iranian hospitals, HVAC&R Research, Vol. 14, Number 2, March 2008, Pages: 175-194; de Dear, R., & Brager, G. S. (1998). Developing an adaptive model of thermal comfort and preference. ASHRAE Transaction, 104(1a), 145-167; Moujalled, B., Cantin, R., & Guarracino, G. (2008). Comparison of thermal comfort algorithms in naturally ventilated office buildings. Energy and Buildings; Zhang, Hui, Arens, Edward, Huizenga, Charlie, Han, Taeyoung. Thermal sensation and comfort models for non-uniform and transient environments: Part I: local sensation of individual body parts, 2009; Zhang, Hui, Arens, Edward, Huizenga, Charlie, Han, Taeyoung. Thermal sensation and comfort models for non-uniform and transient environments: Part II: local comfort of individual body parts, 2009; Zhang, Hui, Arens, Edward, Huizenga, Charlie, Han, Taeyoung. Thermal sensation and comfort models for non-uniform and transient environments: Part III: whole body sensation, 2009; Yu, J., Changzhi, Y. (2009). Evaluation on energy and Thermal Performance for Residential Envelopes in Hot Summer and Cold Winter Zone of China. Applied Energy 86(10) 1970-1985; da Silva, V. D., de Azevedo, P. V. (2009). Evaluating the Urban Climate of a Typically Tropical City of Northeastern Brazil. Environ Monit Assess 2009 Jan. 30. doi:10.1007/s10661-008-0726-3; United States. Environmental Protection Agency. Office of Air and Radiation.; United States. Environmental Protection Agency. Office of the Administrator; Smart Growth Network. (2003)Smart Growth and Urban Heat Islands. U.S. Environmental Protection Agency, Office of Air and Radiation, Office of the Administrator: Smart Growth Network; Shmaefsky, Brian R. (2006). 0ne Hot Demonstration: The Urban Heat Island Effect Journal of College Science Teaching; 35, 7; ProQuest Education Journals pg. 52; Al-Homoud, M., Abdou, A., Budaiwi, I. (2009). Assessment of Monitored Energy Use and Thermal Comfort Conditions in Mosques in Hot-Humid Climates. Energy and Buildings 41(6) 607-614; Nasrollahi, N. (2009). Thermal environments and occupant thermal comfort. VDM Verlag, 2009, ISBN 978-3-639-16978-2; Bernabucci, U., Lacetera, N., (2009). Influence of Different Periods of Exposure to Hot Environment on Rumen Function and Diet Digestibility in Sheep. Int J Biometeorol 2009 Apr. 16; Peeters, L., (2008). Thermal Comfort in Residential Buildings: Comfort Values and Scales for Building Energy Simulation. Applied Energy 86(5) 772-780; Barwood, M. J., Newton, P. S., Tipton, M. J. (2009). Ventilated Vest and Tolerance for Intermittent Exercise in Hot, Dry Conditions with Military Clothing. Aviat Space Environ Med 80(4) 353-359 and Khodakarami, J., Nasrollahi, N., (2012). Renewable and Sustainable Energy Reviews (16)6, August 2012, 4071-4077.

The present invention thus enables and improves zone of comfort as applied in ASHRAE-55 2010 Standard and ANSI/ASHRAE Standard 55[1]; thermal stress as measured by static comfort model, elevated air speed method, adaptive comfort model, improves thermal comfort of livestock and increases thermal comfort for patients and hospital staff and medical patients; and decreases local thermal discomfort; and radiant temperature asymmetry.

In case of ill persons, hospital patients, patients in emergency departments and sexual departments, geriatric clinics, dental clinics etc, zones of comforts significantly improves medical treatment of sick, mentally-impaired, and injured patients; see for example Richard T. Penson et al., Sexuality and Cancer: Conversation Comfort Zone; The Oncologist August 2000, 5(4) 336-344, which is incorporated herein as a reference. The present invention thus enables and improves zone of comfort for those patients and improves medical treatment.

### Example 3

Improving (i) management, command, administration and control; and (ii) facilitating a 2D and/or 3D-rendered entertaining-image or video thereof by superimposing at least one first projected image over at least one second real image.

### Visitor Centers & Operation Environment

Visitor centers frequently utilize two different and separated zones: (i) at the surface of the visitors centers there are located a plurality of glass walls and windows to look at the outside environment: archeological parks, zoos, gardens etc. The widows enable the viewers to see real images (and real images alone), wherein the term ‘real’ relates to a non-manipulated image, namely a real-time image of a object in a defined location. Nevertheless, at an inner portion of those centers, one or more cinema-like audio-video rooms are located. The projection rooms enable the viewers to see unreal images (and unreal images alone). Similarly are designed the command rooms, control facilities and operation cabinets, such as in-car-driver operating environment, in airplane-pilot- operation environment, in-crane-operator operation environment, surgery room in case of the daVinci™ telerobotic surgery system etc.

In one embodiment of the invention the present invention discloses a new and novel design which synergistically integrates both said two different portions or modalities into a unified functional module, which enable the viewer to view, and the operator to operate, simultaneously and concurrently, (i) at least one 2D or 3D screen or at least one portion of a the same viewing real images or real schemes, and (ii) at least one 2D or 3D screen or at least one portion of a the same viewing unreal images or unreal (e.g., video-like) schemes. In another embodiment of the invention the present invention discloses a new and novel 2D or 3D screen which embeds the aforesaid technology is embedded in its glass walls to enable said simultaneous superimposition of real and unreal images.

### Shops-Windows

In another embodiment of the invention the present invention disclosed are new and novel designs of shop-windows, wherein at least one portion of the window, at least temporarily, i.e., at at least in one period of time, at least partially transparent. In this case, the viewer outside the shop can see via said window the real image of the goods which are currently displayed in their predefined location at the shop, whilst he/she sees one or more projected images or video, concurrently projected over the same semi-transparent window. This new mixture of real items and projected advertisement (the projected video or projected images etc) significantly increase the merchantability of the shop; as compared to a regular shop having a “passive” window, and passive projection of video on the shop internal walls.

### More Embodiments of the Invention

A set of various embodiments of the invention is hereby presented in a non-limiting manner to schematically illustrate and unbindingly demonstrate the technology of superimposing at least one first projected image over at least one second real image.

In one embodiment of the invention the present invention discloses a new and novel design which option to dim several layers of glass in different colors to obtain best resolution in correlation every frame being projected on it (adjustable screen).

In another embodiment of the invention the present invention discloses an actual site outside the compound participate in the movie content being projected.

In another embodiment of the invention the present invention discloses “projection screen” disappear in an instant having the view surrounding it as a background.

In another embodiment of the invention the present invention discloses a window which is adapted to automatic shade—for rear back seat windows as well as sunroof or any glass aperture in a vehicle (train bus etc) that is permitted with such technology.

In another embodiment of the invention the present invention discloses means and methods to control the amount of light coming in (for babies for instance) for the driver seat.

In another embodiment of the invention the present invention discloses means and methods for providing privacy for back seat passengers.

In another embodiment of the invention the present invention discloses means and methods for reducing risk while driving via dedicated control from the driver seat.

In another embodiment of the invention the present invention discloses monochromatic screen for Ads.

In another embodiment of the invention the present invention discloses hospitals curtains used for privacy between beds. The existing curtains are very hard to wash (expensive and takes much energy) and may cause people to die in hospitals.

In another embodiment of the invention the present invention discloses lighting systems - today there is a demand from architects and end customers to have the lighting systems “invisible” when not operating—think of the possibility to introduce pigment into the LC foil in the same color the sealing has and then embedded in the glass cover of a sunk lighting system, when off the LC makes it look as though there is nothing in the sealing, when on it opens up and lets the light pass through. U.S. Pat. No. 5,764,316 is acknowledged in this respect and incorporated herein as a reference.

In another embodiment of the invention the present invention discloses transparent whiteboard. in an all glass meeting room, when you need a whiteboard change the glass to translucent.

In another embodiment of the invention the present invention discloses an elevator walls, doors, and windows thereof.

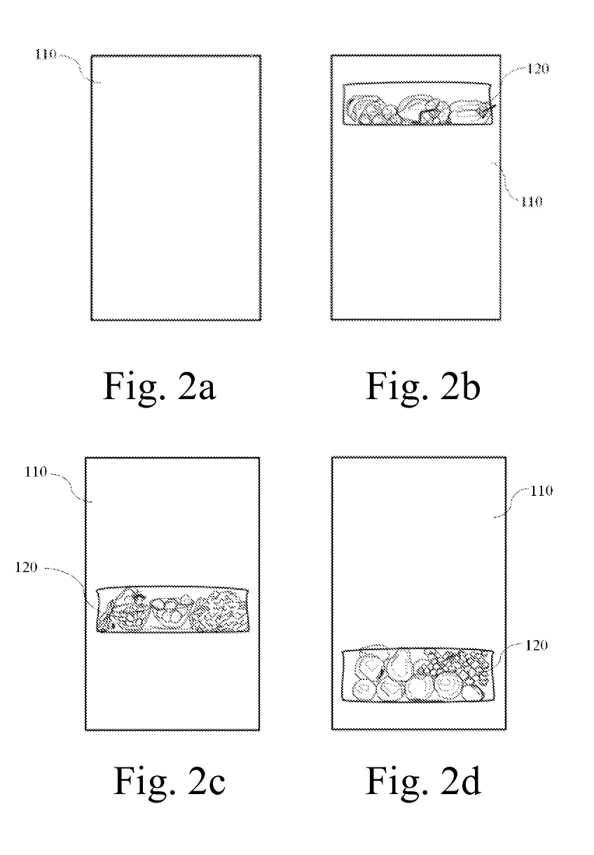

Reference is now made to FIGS. 2a-2d, presenting schematic views of a system for reducing energy usage in a transparent physical element 100. Numerals 110 and 120 refer to transparent and non-transparent portions of the transparent physical element 100. In FIG. 1a, the transparent physical element is totally non-transparent. FIGS. 2a-2d show different locations of the transparent portion 120. Switching between different locations of the transparent portion 120 is switched by means of a power dimmer apparatus (not shown).

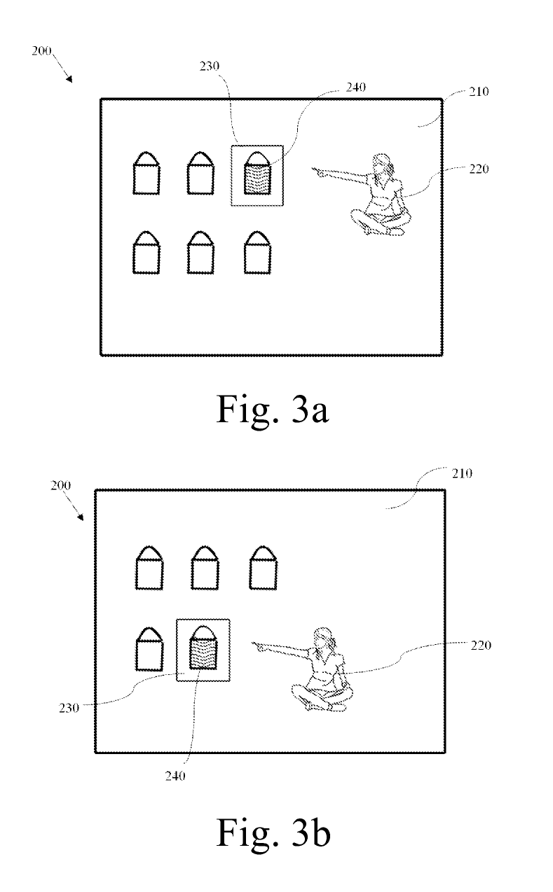

Reference is now made to FIGS. 3a and 3b, presenting schematic views of a showcase 200 which is covered a transparent physical element 210. According to the specific embodiment of the present invention, a content of the showcase (particularly, objects 240 to be advertised) is combined with an image provided by the transparent physical element 210. Specifically, in a non-limiting manner, a transparent portion 230 allows to a predetermined object 240 to be in view. A non-transparent or semi-transparent image 220 can be superimposed onto the content of the showcase 200.

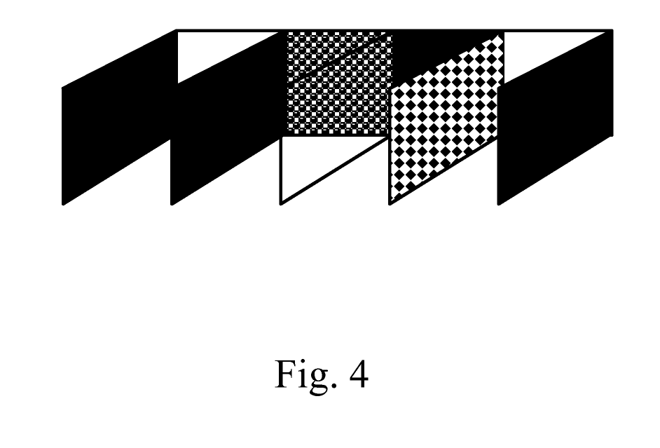

Reference is now made to FIG. 4, presenting a schematic view of a compartment premises formed by transparent physical elements. As shown in FIG. 4, the transparent physical elements can be switched between transparent and non-transparent states. The aforesaid elements can carry a predetermined image or other ornamental compositions.

1. A system for reducing energy usage in a heat controlled device (HCD) comprising:
a. transparency adjustment device (TAD) comprising:
(i) a transparent physical element whose electrical behavior is that of a capacitive load; and
(ii) a power dimmer apparatus operative to provide AC current to said transparent physical element to generate a set of transparency states between opaque and full transparent;
b. a heat control device comprising:
(i) a closed walled cavity; and
(ii) a thermometer adapted to control temperature in said cavity;
wherein said TAD is embedded in at least a portion of said cavity wall; further wherein said TAD reduces said thermometer energy consumption by enabling view of said cavity content without opening said cavity.

2. The system according to claim 1, wherein at least on the following is true:
a. said transparent physical element comprises a liquid crystal (LC) film;
b. said transparent physical element comprises a complex capacitor/resistor load;
c. said power dimmer apparatus comprises: a power switch powering said load; and
control circuit controlling the power switch to turn on and off at a selectable portion of said transparent physical element;
d. power switch comprises: a diode bridge; and a MOSFET switch connected serially with the transparent physical element via the diode bridge;
e. AC voltage applied to the transparent physical element is of a quasi-trapezoidal or truncated sinusoidal form;
f. said power dimmer apparatus is controllable manually controllable by a user;
g. said power dimmer apparatus is controllable by a computerized system such as a PC or smart home system;
h. said cavity is selected from a group consisting of: a refrigerator, an oven, a boiler, a micro-oven and an engine;
i. said cavity additionally comprising a door;
j. said TAD is variably embedded in said cavity wall; and
k. said TAD is movable along said cavity wall.

3. The system according to claim 2, wherein, an AC voltage applied to said transparent physical element is DC balanced within an accuracy of ±5%.

4. The system according to claim 3, wherein the power switch is connected in series with said transparent physical element.

5. The system according to claim 2, wherein the power switch comprises a pair of anti-parallel MOSFET switches connected in series with the transparent physical element.

6. The system according to claim 2, wherein said liquid crystal film is laminated into a glass object thereby to control transparency of the glass object.

7. The system according to claim 6, wherein said glass object forms one of: window pane, a window, a glass door pane, and a glass door.

8. The system according to claim 2, wherein said door additionally comprising a sealing rubber.

9. The system according to claim 8, wherein said TAD reduces erosion of said sealing means by enabling view of said cavity content without opening said cavity.

10. A method for reducing energy usage in a heat controlled device (HCD) comprising steps of:
a. providing a transparency adjustment device (TAD) comprising:
(i) a transparent physical element whose electrical behavior is that of a capacitive load; and
(ii) power dimmer apparatus operative to provide AC current to said transparent physical element to generate a set of transparency states between opaque and full transparent; and
b. a heat control device comprising:
(i) a closed walled cavity; and
(ii) a thermometer adapted to control temperature in said cavity;
wherein said method additionally comprising steps of:
a. embedding said TAD in at least one portion of said cavity wall;
b. reducing said thermometer energy consumption by enabling view of said cavity content without opening said cavity.

11. A system for shading a closed cavity comprising:
a. at least one surface at least partially comprising a transparency adjustment device (TAD) comprising:
(i) a transparent physical element whose electrical behavior is that of a capacitive load; and
(ii) power dimmer apparatus operative to provide AC current to said transparent physical element to generate a set of transparency states between opaque and full transparent; and
b. a cavity comprising said at least one surface buffering between
(i) inside of said cavity; and
(ii) outside of said cavity;
wherein said power dimmer controls shading of said cavity by change of transparency state of said transparent physical element.

12. The system according to claim 11, wherein at least one of the following is true:
a. said cavity is selected from a group consisting of: car, truck, airplane, elevator, train and bus; and
b. said TAD is embedded in a surface selected from the group consisting of: a car window, a sunroof and any combination thereof.

13. A method for shading a closed cavity comprising steps of:
a. providing at least one surface at least partially comprising a transparency adjustment device (TAD) comprising:
(i) a transparent physical element whose electrical behavior is that of a capacitive load; and
(ii) power dimmer apparatus operative to provide AC current to said transparent physical element to generate a set of transparency states between opaque and full transparent;
b. buffering between
(i) inside of said cavity; and
(ii) outside of said cavity, using said at least one surface;
wherein shading said cavity is by changing of transparency state of said transparent physical element using said power dimmer.

14. A system for providing privacy in a shared room comprising:
a. a plurality of N personal spaces within said room; N is an integer greater than 1;
b. a plurality of N−1 transparency adjustment device (TAD) comprising:
(i) a transparent physical element whose electrical behavior is that of a capacitive load; and
(ii) power dimmer apparatus operative to provide AC current to said transparent physical element to generate a set of transparency states between opaque and full transparent;
wherein each of said N−1 TAD is separating between said personal spaces.

15. A method for providing privacy in a shared room comprising:
a. providing a plurality of N−1 transparency adjustment device (TAD) comprising:
(i) a transparent physical element whose electrical behavior is that of a capacitive load; and
(ii) power dimmer apparatus operative to provide AC current to said transparent physical element to generate a set of transparency states between opaque and full transparent;
b. placing each of said TAD between a plurality of N spaces; N is an integer greater than 1;
wherein each of said N−1 TAD is separating between a couple of said personal spaces.

16. A system for concealment of lightning system comprising:
a. at least one surface; said surface is characterized by N parameters; at least one of said N parameters is a transparency parameter;
b. a lightning system recessed inset into said at least one first surface;
c. at least one transparency adjustment device (TAD) comprising:
(i) a transparent physical element whose electrical behavior is that of a capacitive load; and
(ii) power dimmer apparatus operative to provide AC current to said transparent physical element to generate a set of transparency states between opaque and full transparent;
said TAD is configured to cover said lightning system; said TAD is configured to be contiguous with said surface;
wherein said TAD is configured to be in a transparent state coherent with said surface upon detection of lightning system not operating.

17. A screen dynamically interacting with images comprising: a plurality of N transparency adjustment devices (TAD) constructed in structured layers; said TAD comprising:
a. a transparent physical element whose electrical behavior is that of a capacitive load; and
b. power dimmer apparatus operative to provide AC current to said transparent physical element to generate a set of transparency states between opaque and full transparent;
each of said TAD is characterized by a color;
wherein each of said layers is adapted to be independently configured to a different transparency state; thereby screen is adapted to transfer a predetermined portion of an image projected on said screen.

18. A screen for superimposing projected image and real objects comprising: a transparency adjustment devices (TAD) constructed in structured layers; said TAD comprising:
a. a transparent physical element whose electrical behavior is that of a capacitive load; and
b. power dimmer apparatus operative to provide AC current to said transparent physical element to generate a set of transparency states between opaque and full transparent;
said TAD is posted between a projector and an object;
wherein said TAD is adapted to partially transfer an image projected on said TAD by said projector; thereby superimposing said image and said object.
